(19) United States
(12) Patent Application Publication
(10) Pub. No.: US 2023/0244819 A1
(43) Pub. Date: Aug. 3, 2023

(54) SECURING ON-CHIP COMMUNICATION USING CHAFFING AND WINNOWING WITH ALL-OR-NOTHING TRANSFORM

(71) Applicant: University of Florida Research Foundation, Inc., Gainesville, FL (US)

(72) Inventors: Prabhat Kumar Mishra, Gainesville, FL (US); Hansika M. Weerasena Loku Kattadige, Gainesville, FL (US); Thelijjagoda Subodha Nadeeshan Charles, Matara (LK)

(21) Appl. No.: 17/973,768

(22) Filed: Oct. 26, 2022

Related U.S. Application Data
(60) Provisional application No. 63/275,552, filed on Nov. 4, 2021.

(51) Int. Cl. G06F 21/72; G06F 21/85

(52) U.S. Cl. CPC G06F 21/72; G06F 21/85

(57) ABSTRACT

The present disclosure presents systems and methods of secure communication by a system-on-chip. One such method comprises receiving, by a sender of a network-on-chip component of the system-on-chip, a message sequence; transforming, by the sender of the network-on-chip component of the system-on-chip, the message sequence into a pseudo-message sequence with an all-or-nothing transform; performing key-less encryption, by the sender of the network-on-chip component of the system-on-chip, of the pseudo-message sequence to obtain a ciphertext message sequence using a chaffing and winnowing scheme; and transmitting, by the sender of the network-on-chip component of the system-on-chip, the ciphertext message sequence to a receiver of the network-on-chip component of the system-on-chip.

### CROSS-REFERENCE TO RELATED APPLICATION

This application claims priority to co-pending U.S. provisional application entitled, “SECURING ON-CHIP COMMUNICATION USING CHAFFING AND WINNOWING WITH ALL-OR-NOTHING TRANSFORM,” having Ser. No. 63/275,552, filed Nov. 4, 2021, which is entirely incorporated herein by reference.

### STATEMENT REGARDING FEDERALLY SPONSORED RESEARCH OR DEVELOPMENT

This invention was made with government support under 1936040 awarded by the National Science Foundation. The government has certain rights in the invention.

### BACKGROUND

The advancement of manufacturing technologies has enabled the integration of increasingly more diverse intellectual property (IP) cores on the same system-on-chip (SoC). Commercial SoCs, such as the Intel “Xeon Phi” series and Tilera “TILE-Gx” family, consist of SoCs of up to 72 cores. The demand for scalable and high-throughput on-chip interconnects has made network-on-chip (NoC) the standard interconnection solution for many-core SoCs. While optimizing the SoC for performance and energy efficiency is a primary objective, recent manufacturing trends have raised several security concerns. Due to cost as well as time constraints, manufacturers outsource IPs to third-party vendors across the globe. Typically, a few important IPs are manufactured in-house and are integrated with third-party IPs to obtain the final SoC. As a result of this distributed supply chain, malicious implants, such as hardware Trojans, can be inserted into the IPs. Trojans can be inserted into the RTL (register-transfer level) code or into the netlist of an IP core with the intention of launching attacks without being detected at the post-silicon verification stage or during runtime. There are several practical scenarios of Trojan insertion during the long and distributed supply chain, such as by an untrusted CAD tool or designer or at the foundry via reverse engineering. Given the importance of trustworthy computing, there are many research efforts in efficient detection and mitigation of security vulnerabilities. Since NoC facilitates communication between all the IPs, it exposes an ideal threat vector for an attacker to exploit. This allows the attacker to eavesdrop on the NoC packets to extract secret information without hacking into individual IPs. Therefore, protecting the packets transferred on an NoC is a major concern.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a network-on-chip (NoC) implementation using a 4×4 mesh topology.

FIG. 2 provides an overview of an exemplary lightweight key-less encryption framework with chaffing and winnowing (C&W) with all-or-nothing-transform (AONT) in accordance with various embodiments of the present disclosure.

FIG. 3 shows a breakdown of bits from AONT and C&W in accordance with various embodiments of the present disclosure.

FIG. 4 depicts an example of a Latin Square of order 4 and its dual generated as part of an exemplary AOTN process in accordance with various embodiments of the present disclosure.

FIG. 5 and FIG. 6 provide graphs showing the average packet latency and overall execution time respectively with variable C&W bits against AES-128 and no security for a Fast Fourier Transform (FFT) benchmark in accordance with the present disclosure.

FIG. 7 and FIG. 8 provide charts presenting average packet latency and overall execution time respectively using traditional encryption, no security, and an exemplary lightweight key-less encryption scheme in accordance with various embodiments of the present disclosure.

### DETAILED DESCRIPTION

The present disclosure describes various embodiments of systems, apparatuses, and methods for secure on-chip communications utilizing a lightweight key-less encryption scheme based on chaffing and winnowing with an all-or-nothing transform.

A typical SoC consists of a wide variety of IP cores (such as processor, memory, controller, FPGA, etc.) that interact using a Network-on-Chip (NoC) communication subsystem of the system-on-chip. Accordingly, a Network-on-chip (NoC) fulfills the communication requirements of modern System-on-Chip (SoC) architectures. Due to the resource constrained nature of NoC-based SoCs, it is a major challenge to secure on-chip communication against eavesdropping attacks using traditional encryption methods. The present disclosure provides a lightweight encryption technique using chaffing and winnowing with an all-or-nothing transform that benefits from the unique NoC traffic characteristics. An exemplary encryption technique of the present disclosure provides the required security with significantly less area and energy overhead compared to the state of the art approaches.

The major security issues related to NoC can be classified as eavesdropping, spoofing, denial-of-service, buffer overflow, and side-channel attacks. Among the many intellectual property (IP) cores integrated on the SoC, some of them will have secure, crucial information. Since NoC facilitates communication between all the IPs, it exposes an ideal threat vector for an attacker to exploit. This allows the attacker to eavesdrop on the NoC packets to extract secret information without hacking into individual IPs. Therefore, protecting the packets transferred on an NoC is a major concern. However, the added security must not cause significant performance and energy efficiency degradation. Complex security schemes that counter the extraction of secret information, such as AES (Advanced Encryption Standard) encryption, can have a significant impact on overall SoC performance and power consumption, and as a result, they are not suitable for the resource-constrained NoC-based Socs.

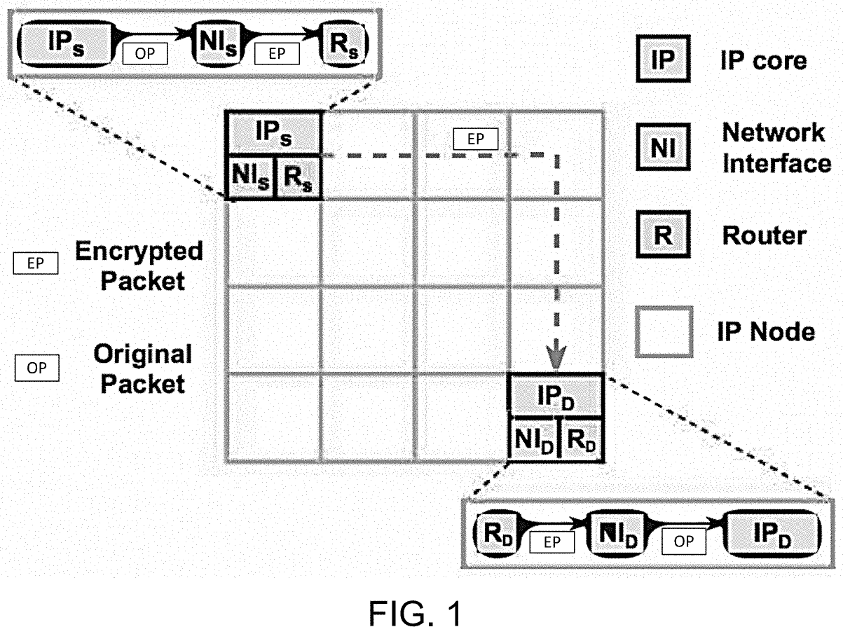

Authenticated encryption is a widely used solution against eavesdropping attacks. FIG. 1 shows a typical NoC implementation on a many-core SoC using a 4×4 mesh topology where packets are encrypted when transferring between IPs. Each IP is connected to the NoC via a network interface and a router. To avoid eavesdropping attack, communication from a source (IPs) (e.g., sender) to a destination (IPs) (e.g., receiver) is encrypted.

Previous work on securing on-chip communication proposed several lightweight encryption schemes. However, these solutions took the traditional path of encryption using block ciphers and made it lightweight by using techniques such as reducing the number of rounds, smaller key sizes, etc. This leads to sub-optimal results in terms of performance, power consumption, and security.

The present disclosure provides a novel lightweight key-less encryption scheme that utilizes the unique characteristics of NoC traffic to derive a lightweight solution while providing the required security. The present disclosure assumes a strong threat model where IPs and several routers can be malicious, and the network interfaces that interface the NoC IP to other IPs are typically manufactured in-house and are assumed to be secure. A similar threat model has been the focus of several other studies, which validates the reality of the model.

System and methods of the present disclosure feature a lightweight key-less encryption scheme employing chaffing and winnowing (C&W) together with an all-or-nothing transform (AONT) that utilizes the unique NoC traffic characteristics. In accordance with embodiments of the present disclosure, the traditional block cipher-based encryption is replaced using a key-less encryption scheme that utilizes C&W and AONT. The performance overhead of deriving realistic “chaff” packets to be dispersed among the “wheat” packets is addressed using NoC traffic characteristics that allocate a predictable sequence number to every packet injected from the same IP. Further, it is shown that the combination of C&W and AONT can provide the desired security guarantees for NoCs.

Next, a brief discussion of background and related works is provided. In general, an All or Nothing Transform (AONT) is a concept originally introduced by Rivest in 1997 to increase the difficulty of launching a brute force attack on encryption algorithms. An AONT is not considered encryption. Instead, it is an invertible, unkeyed, randomized transformation, which acts as a pre-processing step prior to encryption. The main property of an AONT is that when a message is transformed using AONT and then encrypted using a block cipher-based encryption mode, an adversary cannot reveal any information about the message (not even one block) without decrypting all the blocks. For example, typically, to decrypt a block encrypted with a k-bit key using a brute force approach requires 2 k work in the worst case or 2^{k-1} on average. In the ECB (electronic codebook) mode, the adversary only needs to decrypt the first ciphertext block to obtain the corresponding plaintext block. However, using an AONT as a pre-processing step before ECB can increase the work required by orders of magnitude, depending on the encrypted message size. This is helpful in scenarios where the key space size is fixed and the encryption algorithm is considered to be “marginal,” such as the 56-bit DES.

AONT maps the message sequence (m₁, m₂, . . . , mₙ) to (m′₁, m′₂, . . . , m′n) such that (1) the transformation is invertible, (2) AONT and its inverse are effectively computable, and (3) it is infeasible to recover the whole message if at least w bits of the transformation are unknown (encrypted), where w is a threshold related to the security guarantees and in most cases, the size of an AONT block.

There are several AONT implementations, including package transform, optimal asymmetric encryption padding, a variant of the package transform based on the counter mode of encryption, exposure-resilient function-based transform, and quasigroup-based transform. In the present disclosure, an adaptation is used of the AONT proposed by Marnas et al. due to its applicability in resource-constrained environments. See S. I. Marnas, L. Angelis, and G. L. Bleris, “An Application of Quasigroups in All-or-Nothing Transform,” Cryptologia, Vol. 31, No. 2, pp. 133-142 (2007).

Next, consider a finite quasigroup (Q,·) of order n consists of a set Q in which a binary operator is defined that has the following property: ∀a, b∈ Q, the equations a·x=b and y a=b, always have unique solutions for x and y. A dual binary operator can be defined for the binary operator with the following relationship using the elements of set Q:

a∘b=c [symbol] a·c=b

A new finite quasigroup (Q,·) can be derived which is the dual of (Q,·). Using the dual operation, the following relationship can be derived:

a∘(a·b)=b;a·(a∘b)=b

A Latin Square (LS) is an n×n matrix defined on n symbols such that every row and every column contain exactly one occurrence of a specific symbol. For n=3, there are 12 possible LSs and for n=4, there are 576, which shows that possible LSs grow exponentially with n (sequence A002860 in OEIS). See N. J. Sloane et al., The On-Line Encyclopedia of Integer Sequences (OEIS) (2003).

The multiplication table of a quasigroup of size n is a LS of the same order. Therefore, a construction of LSs provides modes of generating random quasigroups. Marnas et al. introduced a fast and randomized method to generate a quasigroup from a LS. See S. I. Marnas, L. Angelis, and G. L. Bleris, “All-or-Nothing Transforms using Quasigroups,” in Proc. 1st Balkan Conference in Informatics, pp. 183-191 (2003). Their approach required the order of the LS to be n=p−1, where p is a prime number. This method can produce n! (n factorial) distinct random LSs of order n. Even though using this method reduces the number of possible LSs, it is obvious that the LS space is still considerably large to prevent brute force attacks (for n=256, LS space≈8.5×10⁵⁰⁶). The present disclosure uses an adaptation of this approach for quasigroup generation to develop an exemplary lightweight key-less encryption scheme in accordance with embodiments of the present disclosure.

Chaffing and winnowing (C&W) is a technique that offers confidentiality without encryption. The technique, which is named after its similarities with removing chaff from wheat, consists of two main processes completed at the two ends of communication— sender and receiver (source IP and destination IP in our case). At the sender, a message authentication code (MAC) is appended to each packet, which is computed using a standard hash-based MAC algorithm. Therefore, each packet originating at the source IP has the packet payload as plaintext and the MAC. Typically, a message consists of multiple packets and therefore, each packet consists of a sequence number to determine the order of the packets that combine to create the message. The sequence number also helps remove duplicate packets and identify missing packets. For example, a message can have the following packet sequence represented with the format (sequence number, payload, MAC):
(1, Our next meeting, 230985)
(2, will be at the docks, 992405)
(3, at midnight June 28, 128476).

These are called “wheat” packets. However, if this is sent as is, the message is not encrypted and any eavesdropper can read the packet data. Therefore, in C&W, confidentially is achieved by adding “chaff” packets to the communication stream.

Chaff packets are fake packets that have the same format and similar-looking content and are intermingled with the wheat packets. A value from a uniformly random distribution is used as the MAC replacement, and therefore, the MAC of each chaff packet is invalid. For example, the above packet sequence after adding chaff can look as follows:
(1, Our next meeting, 230985)
(1, Our next call, 366357)
(2, will be at the docks, 992405)
(2, will be on Signal, 098121)
(3, at midnight June 28, 128476)
(3, at noon May 18, 471298).

The receiver has to discard the chaff packets and retain only the wheat packets to construct the correct message. To do this, the receiver validates the MAC of each packet and discards the packets with invalid MACs. It is important to note that this process of discarding packets with invalid MACs takes place anyway in a typical packet-based communication system that implements authentication. An eavesdropper who cannot validate the MAC is unable to “winnow out” the chaff, and therefore, unable to retrieve the correct message.

The security of a C&W scheme depends on the number of C&W packets, the security of the MAC algorithm, and the way chaffing is done. Bellare and Boldyreva critically evaluated the security of C&W on different notions of security. Their work showed that a bit-by-bit C&W scheme provides “find-then-guess” security. See M. Bellare and A. Boldyreva, “The Security of Chaffing and Winnowing,” in International Conference on the Theory and Application of Cryptology and Information Security, Springer, pp. 517-530 (2000). However, the bit-by-bit scheme requires adding chaff for every wheat bit of the packet, which drastically increases overhead. Therefore, various embodiments of an exemplary lightweight key-less encryption scheme use an adaptation of the bit-by-bit C&W scheme that fits the low overhead requirements of NoC-based SoCs while providing provable security.

Fermat primes are prime numbers that can be expressed in the form of 2²^{ⁿ}+1 where n is a non-negative integer. Currently, there are only five Fermat primes that have been discovered (sequence A019434 in OEIS). The known Fermat primes are Fₒ=3, F1=5, F₂=17, F₃=257, and F₄=65537. In accordance with various embodiments of the present disclosure, an exemplary approach of quasigroup generation and other steps in AONT motivates the usage of Fermat primes.

As noted in discussions involving FIG. 1, eavesdropping attacks in NoC have been addressed by authenticated encryption in prior research efforts, in which content of the packets originating from source IP is encrypted (C) except for the header information (H) and the message authentication tag (T). Thus, the packet injected to the NoC consists of H∥C∥T. Having the header information as plain text helps the routers to process the packets faster and send the packets to the relevant destination. At the destination, the tag is validated to check for tampering and the packet is decrypted. Sepulveda et al. proposed a variation of authenticated encryption as a tunnel-based communication mechanism where only the destination headers are kept as plain text. See J. Sepulveda, A. Zankl, D. Florez, and G. Sigl, “Towards Protected MPSoC Communication for Information Protection Against a Malicious NoC,” Procedia computer science, Vol. 108, pp. 1103-1112 (2017). The authors used AES counter mode for encryption and Siphash for authentication on source headers and data. Although AES counter mode is highly parallelizable for performance gain, it introduces high area and energy overhead. Siphash is a lightweight and fast hash function well suited for short inputs and is an ideal fit for NoC-based SoCs.

Previous works tried to develop lightweight encryption schemes to fit the resource-constrained nature of NoC. A simple XoR cipher together with a packet certification technique was proposed by Ancajas et al. See D. M. Ancajas et al., “Fort-NoCs: Mitigating the Threat of a Compromised NoC,” in DAC, pp. 1-6 (2014). Intel introduced TinyCrypt-a cryptographic library targeting resource-constrained IoT and embedded devices that provides basic functionalities with less overhead. Boraten et al. proposed a reconfigurable packet validation and authentication scheme by merging two robust error detection schemes, namely, algebraic manipulation detection and cyclic redundancy check. See T. Boraten and A. K. Kodi, “Packet Security with Path Sensitization for NoCs,” in 2016 Design, Automation & Test in Europe Conference & Exhibition, IEEE, pp. 1136-1139 (2016). However, these approaches either lead to unacceptable design overhead or do not provide the required security guarantees.

AONT has been used in a wide variety of applications in previous studies. AONT is used as a countermeasure for differential power analysis based side-channel attack in R. P. McEvoy, M. Tunstall, C. Whelan, C. C. Murphy, and W. P. Mamane, “All-or-Nothing Transforms as a Countermeasure to Differential Side-Channel Analysis,” International Journal of Information Security, Vol. 13, No. 3, pp. 291-304 (2014). AONT is also used to protect implementations of cryptographic algorithms against partial key exposures in exposure resilient cryptography. To the best of the inventors' knowledge, an exemplary lightweight key-less encryption scheme of the present disclosure is the first attempt in using AONT with C&W while leveraging the unique NoC traffic characteristics to secure packet transfers in NoC architectures.

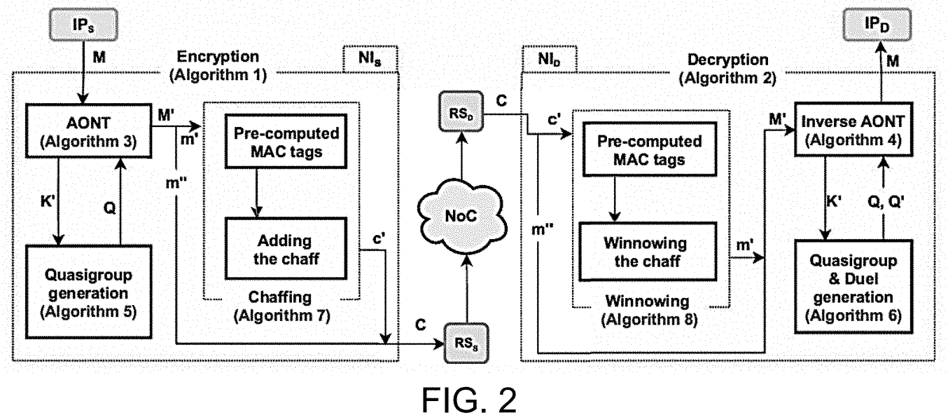

FIG. 2 presents an overview of the lightweight key-less encryption framework in accordance with embodiments of the present disclosure. In various embodiments, the encryption and decryption hardware will be implemented in the network interface since the network interfaces are assumed to be secure according to the threat model. As such, the packet sent from the source (IP_{S}) goes through AONT followed by chaffing which is implemented in the source network interface (NIₛ). The generated ciphertext (C) traverses the NoC to the destination. The destination network interface (NI_{D}) decrypts the packet using winnowing followed by inverse AONT (IAONT) and delivers it to the destination IP (IP_{D}). The following discussion describes an exemplary encryption and decryption procedure using the notations outlined in Table I (below).

TABLE 1
Table of notations.

| | |
|---|---|
| p | One time define Fermat prime |
| n | Size of quasigroup where n = p − 1 |
| s | no of AONT blocks |
| σ(u) | A function that returns a random permutation |
| | of elements 1, ..., u of size u. |
| K′ | Key used to derive the first row of the LS. |
| | \|K′\| = n |
| M | Message to be encrypted |
| M′ | Pseudo-Message after AONT |
| C | Cipher Text |
| Bᵢ | Block in AONT where \|Bᵢ\| = n |
| dᵢ | dᵢ ∈ (1, 2, ..., n) and \|dᵢ\| = log₂ n bits |
| [symbol] Q, ● [symbol] | LS defined by binary operator ● of a quasi- |
| | group |
| qᵢⱼ | Element in row i and column j in LS |
| w | no of C&W bits |
| b̅ᵢ̅ | inverse of bit bᵢ |
| A * B | ∀ a₁ ∈ A & bᵢ ∈ Bᵢ (aᵢ × bᵢ) mod p |
| {0, 1}^{k} | A random permutation of k bits |
| MAC(K, in) | MAC using key K: {0, 1}^{k} → }0, 1}^{z} |
| dt[i] | i^{th} bit of dt bit stream |
| [ ] | empty string |

Algorithm 1 (below) shows the major steps of an exemplary encryption procedure. As the initial setup step, global values of p and ω are selected depending on the security requirements. When the message (M) is sent from the source IP (IPs), it is first transformed using AONT which outputs the pseudo message (M′) (line 2). Then, M′ is divided as m′ and m″ depending on the value of ω (line 3). The first part (m′), which is ω-bits long, undergoes bit-by-bit C&W to produce the “chaffed” output c′ (line 4). Finally, c′ is concatenated with m″ to form the final ciphertext C (line 5).

Algorithm 1 Encryption

| | |
|---|---|
| 1: | function E_{K}(M) |
| 2: | M′ ← AONT(M) |
| 3: | parse M′ as m′ \|\| m″ where \|m′\| = w bits |
| 4: | c′ ← e_{K}(m′) |
| 5: | C ← c′ \|\| m″ |
| 6: | return C |

Decryption follows the reverse of encryption as outlined in Algorithm 2 (below). First, the message (C) is divided into c′ and m″ (line 2). Next, c′ is sent to the “winnowing” process which discards the bits with invalid MACs and returns m′ (line 3). Finally, m′ is concatenated with the m″ to form the M′ (line 4) before applying inverse AONT to produce the original message M (line 5). The required MACs for both wheat and chaff bits can be pre-computed since the sequence number of the packets originating at an IP are predictable (incremented by one for each packet).

Algorithm 2 Decryption

| | |
|---|---|
| 1: | function E_{K}(C) |
| 2: | parse C as c′ \|\| m″ |
| 3: | m′ ← d_{K}(c′) |
| 4: | M′ ← m′ \|\| m″ |
| 5: | M ← IAONT(M′) |
| 6: | return M |

The following discussions elaborate these components in detail starting with the All or Nothing Transformation (AONT). Accordingly, Algorithm 3 (below) describes the AONT invoked in line 2 of Algorithm 1.

Algorithm 3 All or Nothing Transform

| | |
|---|---|
| 1: | function AONT(M) |
| 2: | parse M as B₁ \|\| B₂ \|\| ... \|\| Bₛ where Bᵢ = |
| | (dᵢ₁, dᵢ₂, ..., dᵢₙ) |
| 3: | K′ ← σ(n) |
| 4: | [symbol] Q, ● [symbol] ← Q(K′) |
| 5: | l₁ ← k₁, l₂ ← k₂ ● l₁, ..., lₙ ← kₙ ● lₙ₋₁ and |
| | l ← lₙ |
| 6: | for i = 1, ..., s do |
| 7: | I(i) ← representation of i to number in base |
| | n and \|I(i)\| = n |
| 8: | E(i) ← (eᵢ₁, eᵢ₂, ..., eᵢₙ) where eᵢₙ ← l ● |
| | iᵢₙ, eᵢₙ₋₁ ← eᵢₙ ● iᵢₙ₋₁, ..., eᵢ₁ ← eᵢ₂ ● iᵢ₁ |
| 9: | B′ᵢ ← (d′ᵢ₁, d′ᵢ₂, ..., d′ᵢₙ) where d′ᵢⱼ ← eᵢⱼ ● |
| | dᵢⱼ, j = 1, ..., n |
| 10: | A₁ ← B′₁ |
| 11: | for i=2,...,s do |
| 12: | Aᵢ ← Aᵢ₋₁ * B′ |
| 13: | B′ₛ₊₁ ← Aₛ * K′ |
| 14: | M′ ← B′ᵢ \|\| B′₂ \|\| ... \|\| B′ₛ₊₁ |
| 15: | return M′ |

The message is first transformed to do the arithmetic operations in base n (line 2). For the base transformation to be computationally less demanding, the inventors chose n to be a power of two, which motivated them to use a Fermat prime for p. To achieve this, the message is divided into groups of bits of length log₂ n. Then, each group is represented by a number in base n where its symbols are mapped to the integers {1, . . . , n} (for example when n=4, (00)₂ can be represented as 4 and (11)₂ as 3). The resulting string is divided into s blocks of size n. K′ is generated as a random permutation of {1, . . . , n} (line 3) which is sent as input to an algorithm (Algorithm 5) to generate a quasigroup LS ( [symbol] Q,· [symbol] ) (line 4).

The leader (1) which is required as an initial value is generated through element-wise application of binary operator using the [symbol] Q, · [symbol] (line 5). A single iteration of a for loop from line 6 to 9 maps message block (Bᵢ) to a pseudo message block (B′ᵢ):

At line 7 of Algorithm 3, integer i is represented using a number in base n of length n (for example i=1=(0001)₄ can be represented as (4,4,4,1)). At line 8, intermediate block E(i) is calculated by applying the binary operator on the elements of I(i). The previously calculated leader is used to calculate nth element of E(i). At line 9, a pseudo message block (B′i) is generated from the corresponding message block (Bi) by applying the binary operator element by element with the corresponding E(i) calculated in line 10. Lines 10 to 13 generate the last pseudo block (B'ₛ₊₁). Auxiliary blocks (Aᵢ) are calculated by applying the star operator between and Bᵢ (line 12). Finally, the s+1 concatenated (line 14) blocks are returned as the pseudo message (M′).

Algorithm 4 (below) elaborates the function IAONT, which is the inverse of AONT with the following changes. At line 6, element by element division of Aₛ from B′ₛ₊₁ is used to retrieve K′ based on:

(a*k′)mod p=m′ [symbol] a/m′=k′

At line 7, both LSs including the dual is generated from an algorithm (Algorithm 6) to generate a quasigroup with dual binary operator ∘. At line 12, the dual operator is used to generate the original message blocks from pseudo message blocks.

Algorithm 4 Inverse All or Nothing Transform.

| | |
|---|---|
| 1: | function IAONT(M′) |
| 2: | parse M′ as B′₁ \|\| B′₂ \|\| ... \|\| B′ₛ where B′ᵢ = |
| | (d′ᵢ₁, d′ᵢ₂, ..., d′ᵢₙ) |
| 3: | A₁ ← B′₁ |
| 4: | for i=2,...,s do |
| 5: | Aᵢ ← Aᵢ₋₁ * B′ᵢ |
| 6: | K′ ← Aₛ/B′ₛ₊₁ |
| 7: | [symbol] Q, ● [symbol] , [symbol] Q, ∘ [symbol] ← Q′(K′) |
| 8: | l₁ ← k₁, l₂ ← k₂ ● l₁, ..., lₙ ← kₙ ● lₙ₋₁ and |
| | l ← lₙ |
| 9: | for i = 1, ..., s do |
| 10: | I(i) ← representation of i to number in base |
| | n and \|I(i(\| = n |
| 11: | E(i) ← (eᵢ₁, eᵢ₂, ..., eᵢₙ) where eᵢₙ ← l ● |
| | iᵢₙ, eᵢₙ₋₁ ← eᵢₙ ● iᵢₙ₋₁, ..., eᵢ₁ ← eᵢ₂ ● iᵢ₁ |
| 12: | B(i) ← (dᵢ₁, dᵢ₂, ..., dᵢₙ) where dᵢⱼ ← eᵢⱼ ∘ |
| | d′ᵢⱼ, j = 1, ..., n |
| 13: | M ← Bᵢ \|\| B₂ \|\| ... \|\| Bₛ₊₁ |
| 14: | return M |

Algorithm 5 Generate Quasigroup

| | |
|---|---|
| 1: | function Q(K′) |
| 2: | parse K′ as q₁₁ \|\| q₁₂ \|\| ... \|\| q₁ₙ [symbol] first raw of LS |
| 3: | for i = 2, ..., n do |
| 4: | for j = 1, ..., n do |
| 5: | qᵢⱼ ← (i × q₁ⱼ) mod p |
| 6: | [symbol] Q, ● [symbol] ← LS of qᵢⱼ |
| 7: | return [symbol] Q, ● [symbol] |

Algorithm 6 Generate Quasigroup with Dual

| | |
|---|---|
| 1: | function Q′(K′) |
| 2: | parse K′ as q₁₁ \|\| q₁₂ \|\| ... \|\| q₁ₙ |
| 3: | for i = 1, ..., n do |
| 4: | for j = 1, ..., n do |
| 5: | qᵢⱼ ← (i × q₁ⱼ) mod p |
| 6: | z ← qᵢⱼ |
| 7: | q′_{iz} ← j |
| 8: | [symbol] Q, ● [symbol] ← LS of qᵢⱼ |
| 9: | [symbol] Q, ∘ [symbol] ← LS of q′_{iz} |
| 10: | return [symbol] Q, ● [symbol] , [symbol] Q, ∘ [symbol] |

Certain embodiments of the present disclosure use the LS generation technique introduced by Mamas et al. since it leads to a fast and randomized generation process, as illustrated by Algorithm 5 (above). The size of the LS is n x n where n=p−₁ and p is a prime. The first row of the LS which is a random permutation is provided as a parameter to the algorithm (line 2). Every element of the i-th row, i=₂, . . . , n is computed by (i×q₁ᵢ) mod p (line 5). The generated LS is then used in the AONT calculations.

In various embodiments, Algorithm 6 (above) is used by the receiver to generate both the original quasigroup and its dual simultaneously as LSs. For every element (qᵢⱼ) of row i and column j, a corresponding dual element (q′_{jz}) of value j is generated for row i and column qᵢⱼ(z) (lines 6 and 7).

Algorithm 7 (below) outlines the process of chaffing, where the input message (m′) of length ω is used in the bit by bit C&W process. The final output has ₂ω packets because there is a chaff bit for each bit in m′. The m′ is treated as a bit stream and the steps shown in line 3 to line 7 are applied on every bit of m′. A tag (tg^{i, b}) is generated by a secure MAC algorithm for the bit bᵢ and counter (ctr) using the shared authentication key K (line 4). In an exemplary implementation, a NoC packet sequence number and an offset were used as the value of ctr. A random tag (tg^{i, b}) is generated for the complement of the bit (line 5). Two packets are generated for the original bit and the complement bit as a combination of the bit, ctr, and tag (line 6 & 7).

Algorithm 7 Chaffing

| | |
|---|---|
| 1: | function e_{K}(m′) |
| 2: | break m′ into bits as b₁ \|\| b₂ \|\| ... \|\| b_{w} |
| 3: | for i = 1, ..., w do |
| 4: | tg^{i,b} ← MAC(K, bᵢ \|\| [symbol] ctr + i [symbol] ) |
| 5: | tg^{i,b̅} [symbol] {0, 1}\|K\| |
| 6: | Pkt^{i,0} ← (bi \|\| [symbol] ctr + i [symbol] , tg^{i,0}) |
| 7: | Pkt^{i,1} ← (b̅i̅ \|\| [symbol] ctr + i [symbol] , tg^{i,1}) |
| 8: | return Pkt^{1,0}, Pkt^{1,1}, ..., Pkt^{w,0}, PKt^{w,1} |

In an exemplary approach, among others, MAC can be generated in parallel, without waiting for the bits (m′) to arrive since the sequence number of each packet is predictable in NoC architectures and only one bit is used from m′ for each tg^{i,b}. This enables significant performance improvement.

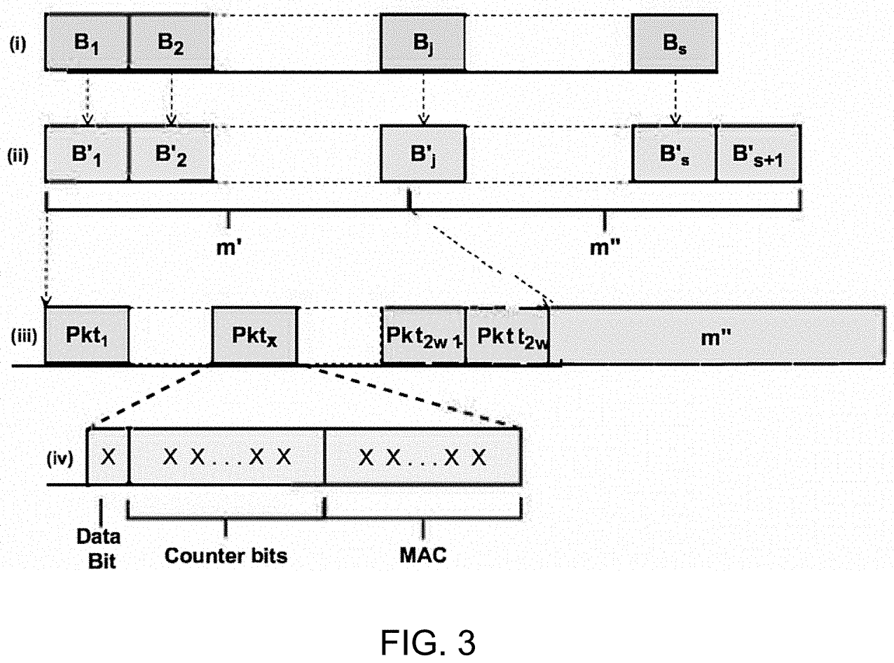

Algorithm 8 (below) outlines the winnowing process, where the process takes 2ω packets and outputs the original bit stream of length w. Each packet is validated using the same MAC algorithm and the key K (line 5). Invalid packets are discarded and the bit values of the valid packets are concatenated to produce the original message. The chaffing process increases the number of flits since for each bit in m′, a tag and a counter are appended. However, as shown in experimental results, the impact on performance due to the increase in congestion is compensated by the faster encryption (and decryption). FIG. 3 elaborates how the bits are composed in the final ciphertext compared to the original message with (i) an original packet divided into blocks for AONT, (ii) transformed blocks after AONT, (iii) m′ converted to 2ωw C&W packets, and (iv) an overview of a chaffed packet.

Algorithm 8 Winnowing

| | |
|---|---|
| 1: | function d_{K}(Pkt₁, ..., Pkt_{2w}) |
| 2: | m′ ← [ ] |
| 3: | for i = 1, ..., 2w do |
| 4: | parse Pktᵢ as dtᵢ \|\| tgᵢ |
| 5: | if MAC(K, d₁) = tgᵢ then |
| 6: | m′ \|\| dtᵢ[1] |
| 7: | return m′ |

Next, an illustrative example is provided to show how AONT and C&W work together to secure NoC packets. Let M be the message sent by the sender:
M=0101 1111 0110 1000 1101 1010 1011 1100 1110 0001,
   and p and ω be set to 5 and 4, respectively. Since p=5, n=4 in accordance with Table I. Now, let the chosen alphabet be 1,2,3,4 where the binary equivalent of 00 is represented by 4. Therefore, the message M can be represented as
M=11331224312223343241
   where the blocks are
B₁=(1, 1, 3, 3) B₂=(1, 2, 2, 4)
B₃=(3, 1, 2, 2) B₄=(2, 3, 3, 4)
B₅=(3, 2, 4, 1).

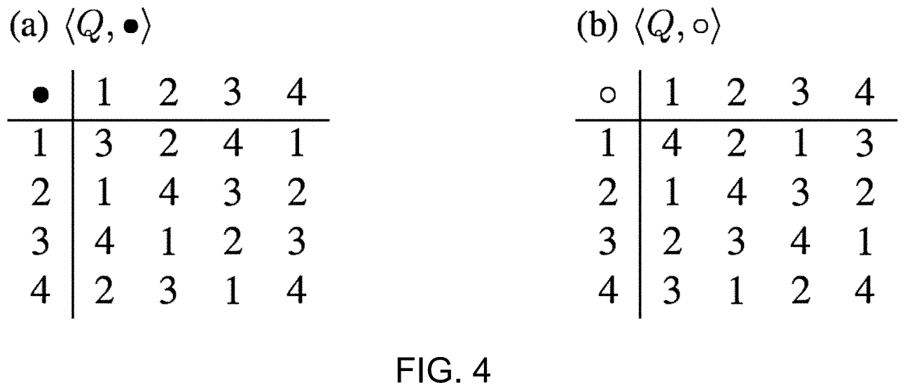

Assume that the derived random key is K′=(3, 2, 4, 1). Part A of FIG. 4 shows the LS [symbol] Q,· [symbol] constructed by Algorithm 5.

The leader can be calculated as:

l₁=3,l₂−2·3=3,l₃=4·3=1,l₄=1·1=3and l=3.

Calculation of I(i):

I(1)=(4,4,4,1)I(2)=(4,4,4,2)

I(3)=(4,4,4,3)I(4)=(4,4,1,4)

I(5)=(4,4,1,1)

Calculation of E (i):

E(1)=(4,4,4,4)E(2)=(3,3,3,3)

E(3)=(2,2,2,2)E(4)=(3,1,1,3)

E(5)=(2,2,2,4)

Calculation of pseudo-message blocks B′i:

B′₁=(2,2,1,1)B′₂=(4,1,1,3)

B′₃=(3,1,4,4)B′₄=(3,1,1,3)

B′₅=(3,4,2,2)

Calculation of Auxiliary A:

A₁=(2,2,1,1)A₂=(3,2,1,3)

A₃=(4,2,4,2)A₄=(2,2,4,1)

A₅=(1,3,3,2)

Using the above results, the final pseudo-message block can be calculated as

B′₆=A₅*K=(1,3,3,2)*(3,2,4,1)=(3,1,2,2)

### Thus, M′=2211 4113 3144 3113 3422 3122.

The last block of M′, which is 3122, in this example is the extra block added by AONT. For the Pseudo-message binary representation:

M′=10100101 00010111 11010000 11010111 11001010 11011010

Let ω=4 and ctr=1 for C&W. Then,

m′=1010,m″=0101 00010111 11010000 11010111 11001010 11011010

Let the outputs of tg be

tg^{1,1}=1011tg^{2,0}=1010

tg^{3,1}=1110tg^{4,0}=1111

Using the calculated tag values to derive and chaff and wheat packets, we get the following. Wheat packets:

Pkt^{1,1}=(1,1,1011)Pkt^{2,0}=(0,2,1010)

Pkt^{3,1}=(1,3,1110)Pkt^{4,0}=(0,4,1111)

Chaff packets:

Pk^{1,0}=(0,1,0011)Pkt^{2,1}=(1,2,0011)

Pkt^{3,0}=(0,3,0111)Pkt^{4,1}=(1,4,0101)

Then, the c′ can be computed as

c′=Pkt^{1,0}∥Pkt^{1,1}∥Pkt^{2,0}∥Pkt^{2,1}∥Pkt^{3,0}∥Pkt^{3,1}∥Pkt^{4,0}∥Pkt^{4,1}

If |ctr|=₃ bits, binary representation of c′ is:

c′=00010011∥10011011∥00101010∥10100011∥00110111∥10111110∥01001111∥11000101

Finally, ciphertext (C) is c′∥m″.

At the receiver's side, the winnowing process constructs m′ by winnowing the chaff as outlined in Algorithm 8 (above) and constructs M′. The IAONT process parses M′ to derive B′ᵢ and Aᵢ and retrieves the key as:

K=(1,3,3,2)/(3,1,2,2)=(3,2,4,1).

Both LSs [symbol] Q,· [symbol] and its dual [symbol] Q,∘ [symbol] are constructed using Algorithm 6 as in FIG. 4. Calculated I(i) and E(i) will be similar to the senders' side. Original blocks (Bᵢ) of the message (M) can be constructed using B′ᵢ: and (Q,∘) LS.

To evaluate the effectiveness of an exemplary lightweight key-less encryption scheme, a cycle-accurate full system gem5 simulator was used. The “GARNET2.0” model was used as on-chip interconnection model. The configuration parameters used in gem5 is outlined in Table II (below).

TABLE II
Processor configuration

| | |
|---|---|
| Number of cores | 76 |
| Core frequency | 2 GHz |
| Instruction Set Architecture | x86 |

Memory System Configuration

| | |
|---|---|
| L1 instruction cache | private separate cache of 16 kB |
| L2 data cache | private separate cache of 16 kB |
| Cache coherence | directory-based cache coherence protocol |
| Memory size | 4 GB DDR |

Interconnection Network Configuration

| | |
|---|---|
| | 4 × 4 Mesh topology |
| Routing Scheme | X-Y deterministic |
| Link Latency | 1 Cycle |

The inventors modified the Network Interface (NI) of the gem5 source to simulate the disclosed approach as well as the traditional encryption. Multiple benchmarks from SPLASH-2 and PARSEC benchmarks were run as applications to capture performance data. To evaluate the area and energy overhead of an exemplary approach of the present disclosure against traditional encryption, both methods were synthesized using Synopsys Design Compiler with an “Isi_I0k” library.

GARNET2.0 default implementation has data packet size of 576 bits. For the AONT parameters, this motivated the inventors to use a LS size(n) of 16 which led to an AONT block size of 64 bits. For the C&W parameters, both the counter and the MAC tag size are kept as 8 bits. The number of C&W bits (w) is kept as a variable which can be chosen according to the desired level of security.

For the present disclosure, an exemplary lightweight key-less encryption approach was compared with symmetric encryption of AES-128. Since an exemplary AONT implementation works on blocks in parallel, it is compared with AES-128 in parallel CTR mode of encryption to enable a fair comparison. In this case, 576 bits of data require 5 parallel block ciphers of AES-128.

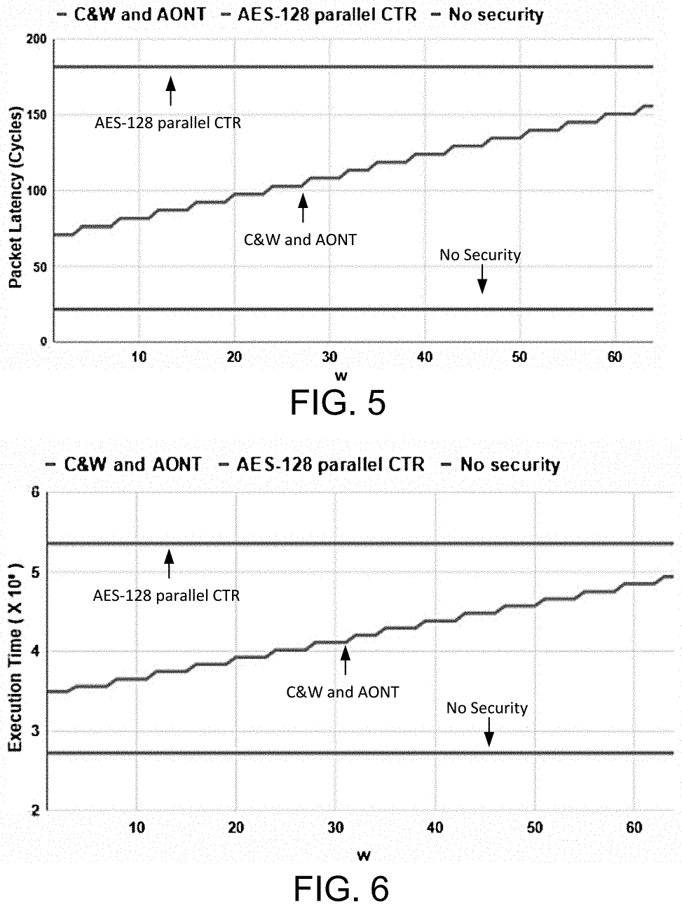

The performance of the exemplary approach (C&W and AONT) is compared with two other scenarios: (1) No security-NoC architecture that does not implement encryption to secure communication, and (2) AES-128 parallel CTR-packets secured using five AES-128 ciphers in counter mode. FIG. 5 and FIG. 6 show the average packet latency and overall execution time, respectively, with varying w values when running the FFT benchmark from the SPLASH-2 benchmark suite.

Packet latency is the number of cycles taken by one packet to traverse from source to destination. There is an average packet latency even in the “No security” scenario because of delays at the network interface, links, and routers in the NoC. AES-128 parallel CTR has high packet latency due to additional encryption operations taking place at the network interface. Overall execution time consists of CPU cycles, memory load/store delays in addition to the delays traversing the NoC.

The AONT implementation introduces n log₂ n number of bits to packets which is constant for the selected LS. However, C&W introduces a variable amount of bits (2ω(|ctr|+|tag|+1)−ω) depending on the number of C&W bits (ω). The increasing number of bits contributes to the increasing number of flits injected into the network and as a result, increased packet latency. However, the performance penalty due to congestion is compensated by faster encryption in the exemplary approach of the present disclosure.

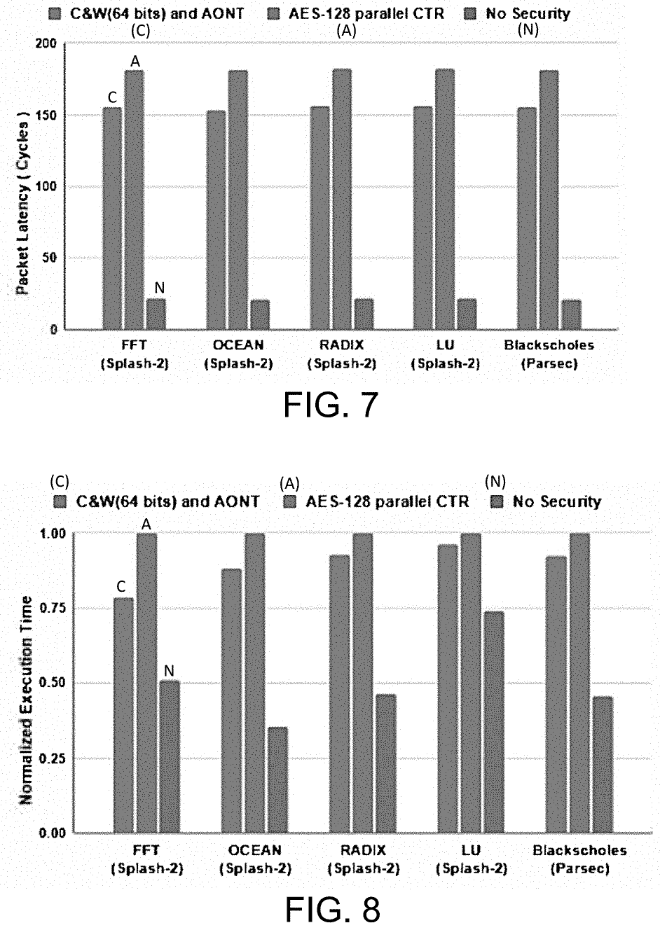

The inventors chose ω=64 experimentally according to the observations and evaluated the exemplary approach against traditional encryption across multiple benchmarks of SPLASH-2 and PARSEC, namely, FFT, OCEAN, RADIX, LU, and Blackscholes, where FIG. 7 presents the average packet latency and FIG. 8 presents the overall execution time across multiple benchmarks. It can be observed that the exemplary lightweight key-less encryption scheme behaves similarly across all benchmarks. The exemplary approach offers 14.3% improvement in packet latency and 7.7% improvement in overall execution time compared to traditional AES-128 encryption.

Table III (below) presents results based on the area and energy consumption calculations considering the same three scenarios. Each network interface must implement the required additional hardware for the security mechanism. For the ease of illustration, the overhead at one network interface is shown in Table III. The exemplary lightweight key-less encryption approach improves the area overhead by 48.1% and energy efficiency by 72.1% compared to traditional encryption. The energy consumption is calculated for encrypting a 576-bit message. The exemplary approach increases the energy efficiency significantly since AES-128 takes longer to encrypt and also, requires more power to run the five block ciphers in parallel. Therefore, the exemplary lightweight key-less encryption approach or scheme is ideal for resource-constrained NoC architectures.

TABLE IIII

| | AES-128 | C&W(64 bit) | |
|---|---|---|---|
| | parallel CTR | with AONT | Improvement |
| Area | 1505781 | 780164 | 48.1% |
| Energy(μJ) | 16.6 | 4.6 | 72.1% |

Security of the disclosed approach, which utilizes both bit-by-bit C&W and AONT, depends on the security of the two main components: (1) the implementation of the MAC algorithm used in the C&W scheme, and (2) security of the AONT scheme. Bit-by-bit C&W scheme is proven to provide “find-then-guess” security assuming the underlying MAC is a pseudo-random function. AONT scheme used in the disclosed approach is introduced as a secure AONT scheme by Mamas et al. as it followed the steps of package transform defined using quasigroup. See S. I. Marnas, L. Angelis, and G. L. Bleris, “An Application of Quasigroups in All-or-Nothing Transform,” Cryptologia, Vol. 31, No. 2, pp. 133-142 (2007). The package transform is proven to be secure with a strong semantic security model.

If fewer bits are used for C&W, the advantage of the adversary is higher. The advantage decreases exponentially with the increasing number of bits for C&W (ω) because of the find-then-guess notion of security in the bit-by-bit C&W scheme. This makes the security of an exemplary lightweight key-less encryption approach configurable based on the security requirement and performance overhead.

Exhaustive key search attack is not possible in the disclosed approach compared to traditional encryption because AONT is key-less. For example, if ω=64, s=9 and n=16, an adversary needs to brute force 2⁽⁶⁴⁺⁹⁾/2 trials on average, which is 272 trials to recover the first row of the LS (K′). Also, it will be changed in the next message and there are 16! (n!) number of possible K′ values. In other words, the attacker has to perform 2⁷² trials for every message, which is infeasible in practice.

The usage of AONT has also shown to hinder the possibility of differential side-channel analysis. See R. P. McEvoy, M. Tunstall, C. Whelan, C. C. Murphy, and W. P. Mamane, “All-or-Nothing Transforms as a Countermeasure to Differential Side-Channel Analysis,” International Journal of Information Security, Vol. 13, No. 3, pp. 291-304 (2014). This can be considered as an added advantage of the exemplary lightweight key-less encryption approach over traditional encryption. Therefore, the disclosed approach is sufficiently secure in resource constraint environments such as NoC-based SoCs.

In conclusion, Network-on-Chip (NoC) is a widely used solution for on-chip communication between Intellectual Property (IP) modules in System-on-Chip (SoC) architectures. The increased usage of NoC and its distributed nature across the chip has made it a focal point of potential security attacks. However, it may not be feasible to implement costly encryption schemes on resource-constrained NoC-based SoCs. While parallel encryption methods can mitigate performance overhead, they can lead to unacceptable area and power penalties. In accordance with the present disclosure, a lightweight key-less encryption scheme is provided based on chaffing and winnowing with an all-or-nothing transform. Exemplary chaffing and winnowing algorithms can be tuned to address the trade-off between security and design overhead. Experimental results demonstrate that an exemplary lightweight key-less encryption approach can provide the desired security guarantees for resource-constrained SoCs while incurring significantly lower energy and performance overhead compared to the state-of-the-art encryption methods.

Certain embodiments of the present disclosure can be implemented in hardware, software, firmware, or a combination thereof. If implemented in software or firmware, exemplary logic or functionality is stored in a memory and that is executed by a suitable instruction execution system. If implemented in hardware, the logic or functionality can be implemented with any or a combination of the following technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

1. A method of secure communication by a system-on-chip comprising:
receiving, by a sender of a network-on-chip component of the system-on-chip, a message sequence;
transforming, by the sender of the network-on-chip component of the system-on-chip, the message sequence into a pseudo-message sequence with an all-or-nothing transform;
performing key-less encryption, by the sender of the network-on-chip component of the system-on-chip, of the pseudo-message sequence to obtain a ciphertext message sequence using a chaffing and winnowing scheme; and
transmitting, by the sender of the network-on-chip component of the system-on-chip, the ciphertext message sequence to a receiver of the network-on-chip component of the system-on-chip.

2. The method of claim 1, wherein the sender and the receiver each comprise an intellectual property core of the system-on-chip.

3. The method of claim 1, wherein the ciphertext message sequence comprises wheat packets comprising at least a portion of the pseudo-message sequence and fake chaff packets that have a same format as the wheat packets, wherein each wheat packet shares a sequence number with one of the fake chaff packets.

4. The method of claim 3, wherein the chaffing and winnowing scheme comprises a bit-by-bit chaffing and winnowing scheme.

5. The method of claim 4, wherein each wheat packet comprises a counter value, a bit of the portion of the pseudo-message sequence, and a message authentication code value, wherein the counter value comprises a sequence value for the message sequence.

6. The method of claim 4, wherein the pseudo-message sequence is split into a first portion and a second portion, wherein the first portion undergoes the bit-by-bit chaffing and winnowing scheme to produce an output sequence comprising the wheat packets and the fake chaff packets, wherein the output sequence is concatenated with the second portion to produce the ciphertext message sequence.

7. The method of claim 6, further comprising:
receiving, by the receiver of the network-on-chip component of the system-on-chip, the ciphertext message sequence;
splitting, by the receiver of the network-on-chip component of the system-on-chip, the ciphertext message sequence into the output sequence and the second portion of the pseudo-message sequence;
decrypting, by the receiver of the network-on-chip component of the system-on-chip, the output sequence into the first portion of the pseudo-message sequence by removing the fake chaff packets from the output sequence;
forming, by the receiver of the network-on-chip component of the system-on-chip, the pseudo-message sequence by concatenating the first portion of the pseudo-message sequence and the second portion of the pseudo-message sequence; and
transforming, by the receiver of the network-on-chip component of the system-on-chip, the pseudo-message sequence into the message sequence using an inverse all-or-nothing transform.

8. The method of claim 1, further comprising:
receiving, by the receiver of the network-on-chip component of the system-on-chip, the ciphertext message sequence;
decrypting, by the receiver of the network-on-chip component of the system-on-chip, the ciphertext message sequence into the pseudo-message sequence; and
transforming, by the receiver of the network-on-chip component of the system-on-chip, the pseudo-message sequence into the message sequence.

9. The method of claim 1, wherein the all-or-nothing transform is implemented using quasigroups.

10. The method of claim 9, wherein the quasigroups comprise Latin squares.

11. An integrated circuit chip system comprising:
a system-on-chip; and
a network-on-chip, wherein the network-on-chip comprises a communication subsystem of the system-on-chip that is configured to:
receive, by a sender of a network-on-chip component of the system-on-chip, a message sequence;
transform, by the sender of the network-on-chip component of the system-on-chip, the message sequence into a pseudo-message sequence with an all-or-nothing transform;
perform key-less encryption, by the sender of the network-on-chip component of the system-on-chip, of the pseudo-message sequence to obtain a ciphertext message sequence using a chaffing and winnowing scheme; and
transmit, by the sender of the network-on-chip component of the system-on-chip, the ciphertext message sequence to a receiver of the network-on-chip component of the system-on-chip.

12. The system of claim 11, wherein the sender and the receiver each comprise an intellectual property core of the system-on-chip.

13. The system of claim 11, wherein the ciphertext message sequence comprises wheat packets comprising at least a portion of the pseudo-message sequence and fake chaff packets that have a same format as the wheat packets, wherein each wheat packet shares a sequence number with one of the fake chaff packets.

14. The system of claim 13, wherein the chaffing and winnowing scheme comprises a bit-by-bit chaffing and winnowing scheme, wherein each wheat packet comprises a counter value, a bit of the portion of the pseudo-message sequence, and a message authentication code value.

15. The system of claim 14, wherein the counter value comprises a sequence value for the message sequence.

16. The system of claim 14, wherein the pseudo-message sequence is split into a first portion and a second portion, wherein the first portion undergoes the bit-by-bit chaffing and winnowing scheme to produce an output sequence comprising the wheat packets and the fake chaff packets, wherein the output sequence is concatenated with the second portion to produce the ciphertext message sequence.

17. The system of claim 16, wherein the network-on-chip is further configured to:
receive, by the receiver of the network-on-chip component of the system-on-chip, the ciphertext message sequence;
split, by the receiver of the network-on-chip component of the system-on-chip, the ciphertext message sequence into the output sequence and the second portion of the pseudo-message sequence;
decrypt, by the receiver of the network-on-chip component of the system-on-chip, the output sequence into the first portion of the pseudo-message sequence by removing the fake chaff packets from the output sequence;
form, by the receiver of the network-on-chip component of the system-on-chip, the pseudo-message sequence by concatenating the first portion of the pseudo-message sequence and the second portion of the pseudo-message sequence; and
transform, by the receiver of the network-on-chip component of the system-on-chip, the pseudo-message sequence into the message sequence using an inverse all-or-nothing transform.

18. The system of claim 11, wherein the network-on-chip is further configured to:
receive, by the receiver of the network-on-chip component of the system-on-chip, the ciphertext message sequence;
decrypt, by the receiver of the network-on-chip component of the system-on-chip, the ciphertext message sequence into the pseudo-message sequence; and
transform, by the receiver of the network-on-chip component of the system-on-chip, the pseudo-message sequence into the message sequence.

19. The system of claim 11, wherein the all-or-nothing transform is implemented using quasigroups.

20. The system of claim 19, wherein the quasigroups comprise Latin squares.
